(19) United States
(12) Patent Application Publication
(10) Pub. No.: US 2024/0370297 A1
(43) Pub. Date: Nov. 7, 2024

(54) RESOURCE SCHEDULING SYSTEM AND METHOD

(71) Applicant: Hangzhou AliCloud Feitian Information Technology Co., Ltd., Hangzhou, Zhejiang (CN)

(72) Inventors: Yang ZHANG, Beijing (CN); Yihui FENG, Beijing (CN); Yangqing JIA, Hangzhou (CN); Wei LIN, Hangzhou (CN); Chao LI, Hangzhou (CN)

(21) Appl. No.: 18/685,778

(22) PCT Filed: Jan. 28, 2023
(86) PCT No.: PCT/CN2023/073540

§ 371 Date: Feb. 22, 2024

(30) Foreign Application Priority Data
Jan. 29, 2022 (CN) 2022101110747

(51) Int. Cl. G06F 9/50; G06F 9/48

(52) U.S. Cl. CPC G06F 9/5005; G06F 9/4881

(57) ABSTRACT

Embodiments of the present specification provide a resource scheduling system and method, where a task processor receives a task processing request submitted for a task to be processed, and creates, based on the task processing request, a resource acquiring request and send same to a scheduler; a resource processing node receives the task processing request, and creates, based on the task processing request, schedulable resource information and sends same to the scheduler; the scheduler executes, according to the resource acquiring request and the schedulable resource information, resource scheduling on the task to be processed, to obtain a resource scheduling result, and sends the resource scheduling result to the resource processing node and the task processor. The resource acquiring request and the schedulable resource information are respectively sent by the task processor and the resource processing node to the scheduler directly.

### CROSS-REFERENCE TO RELATED APPLICATIONS

The present application is a National Stage of International Application No. PCT/CN2023/073540, filed on Jan. 28, 2023, which claims priority to Chinese Patent Application No. 202210111074.7, filed on Jan. 29, 2022 to the China National Intellectual Property Administration and entitled “RESOURCE SCHEDULING SYSTEM AND METHOD”. These applications are incorporated into the present application by reference in their entireties.

### TECHNICAL FIELD

Embodiments of the present specification relate to the field of computer technology and, in particular, to a resource scheduling system and method.

### BACKGROUND

With the development of computer technology, the number of resource scheduling requests that a resource scheduler needs to process is also growing increasingly. An interface program receives and stores resource scheduling requests submitted by a service manager, and sequentially sends the resource scheduling requests to the resource scheduler. The resource scheduler processes the resource scheduling requests, and after determining resource scheduling results, sends the resource scheduling results to the corresponding service manager.

At the same time, under a situation where the number of the resource scheduling requests received by the interface program is relatively huge, it is impossible to quickly send the resource scheduling requests to the resource scheduler. Therefore, there is an urgent need for a resource scheduling method to solve this problem.

### SUMMARY

In view of this, an embodiment of the present specification provides a resource scheduling system. One or more embodiments of the present specification simultaneously involve an information processing method, a resource scheduling method, a computing device, a computer readable storage medium, and a computer program, in order to address technical deficiencies in prior art.

According to a first aspect of the embodiments of the present specification, a resource scheduling system is provided, and the system includes:

a scheduler and a task manager, where the task manager includes a task processor and a resource processing node:

the task processor is configured to: receive a task processing request submitted for a task to be processed: and create, based on the task processing request, a resource acquiring request and send the resource acquiring request to the scheduler;

the resource processing node is configured to: receive the task processing request: and create, based on the task processing request, schedulable resource information and send the schedulable resource information to the scheduler:

the scheduler is configured to: execute, according to the resource acquiring request and the schedulable resource information, resource scheduling on the task to be processed, to obtain a resource scheduling result: and send the resource scheduling result to the resource processing node and the task processor.

According to a second aspect of the embodiments of the present specification, an information processing method is provided, which is applied to the resource scheduling system mentioned above. The method includes:

determining, by a task manager, service information in response to a service request, and reading an initial transmission parameter: updating, based on the service information, the initial transmission parameter to a target transmission parameter; and sending the service information and the target transmission parameter to a scheduler, and storing them to a transmission information queue:

determining, by the scheduler, feedback information according to the service information and the target transmission parameter under a situation of receiving the service information and the target transmission parameter, and reading an initial receiving parameter; and updating, based on the feedback information, the initial receiving parameter to a target receiving parameter, and sending the feedback information and the target receiving parameter to the task manager:

receiving, by the task manager, the feedback information and the target receiving parameter: updating, based on the target receiving parameter, a state parameter corresponding to the service information and the target transmission parameter, and updating the transmission information queue according to the updated state parameter.

According to a third aspect of the embodiments of the present specification, a resource scheduling method is provided, and the method includes:

receiving, by a task processor, a task processing request submitted for a task to be processed: and creating, based on the task processing request, a resource acquiring request and sending the resource acquiring request to a scheduler:

receiving, by a resource processing node, the task processing request: and creating, based on the task processing request, schedulable resource information and sending the schedulable resource information to the scheduler;

executing, by the scheduler according to the resource acquiring request and the schedulable resource information, resource scheduling on the task to be processed, to obtain a resource scheduling result: and sending the resource scheduling result to the resource processing node and the task processor.

According to a fourth aspect of the embodiments of the present specification, a computing device is provided, and the computing device includes:

a memory and a processor:

where the memory is configured to store computer executable instructions, the processor is configured to execute the computer executable instructions, when the computer executable instructions are executed by the processor, steps of the resource scheduling method or the information processing method mentioned above are implemented.

According to a fifth aspect of the embodiments of the present specification, a computer readable storage medium is provided, and it stores computer executable instructions, when the instructions are executed by a processor, steps of the resource scheduling method or the information processing method mentioned above are implemented.

According to a sixth aspect of the embodiments of the present specification, a computer program is provided, where when the computer program is executed in a computer, the computer is enabled to execute steps of the resource scheduling method or the information processing method mentioned above.

According to the resource scheduling system provided by the present specification, when performing resource scheduling, the task processor receives the task processing request submitted for the task to be processed, and creates, based on the task processing request, the resource acquiring request and sends same directly to the scheduler; after receiving the task processing request, the resource processing node creates schedulable resource information based on the task processing request and sends same to the scheduler: the scheduler executes, according to the resource acquiring request and the schedulable resource information, resource scheduling on the task to be processed, and after obtaining the resource scheduling result, sends the resource scheduling result to the resource processing node and the task processor, to complete the resource scheduling. The resource acquiring request and the schedulable resource information are respectively sent by the task processor and the resource processing node to the scheduler directly: thus shorting waiting time for the scheduler to obtain the resource acquiring request and the schedulable resource information, and increasing feedback speed of the task processing request.

### BRIEF DESCRIPTION OF DRAWINGS

FIG. 1 is a schematic structure diagram of a resource scheduling system provided in an embodiment of the present specification.

FIG. 2 is a schematic diagram of a processing procedure of a resource scheduling system provided in an embodiment of the present specification.

FIG. 3 is a schematic interaction diagram of a resource scheduling system provided in an embodiment of the present specification.

FIG. 4 is a flowchart of an information processing method provided in an embodiment of the present specification.

FIG. 5 is a schematic diagram of a processing procedure of an information processing method provided in an embodiment of the present specification.

FIG. 6 is a schematic interaction diagram of an information processing method provided in an embodiment of the present specification.

FIG. 7 is a flowchart of a resource scheduling method provided in an embodiment of the present specification.

FIG. 8 is a block diagram of a structure of a computing device provided in an embodiment of the present specification.

### DESCRIPTION OF EMBODIMENTS

Many specific details are elaborated in the following description to fully understand the present specification. However, the present specification can be implemented in many other ways different from those described herein, and those skilled in the art can make similar extensions without violating the purport of the present specification. Therefore, the present specification is not limited by the specific implementation disclosed below.

Terms used in one or more embodiments of the present specification are for the sole purpose of describing specific embodiments and are not intended to limit one or more embodiments of the present specification. The singular forms of “one”, “said”, and “the” used in one or more embodiments of the present specification and the appended claims are also intended to include the plural forms, unless the context clearly indicates other meanings. It should also be understood that the terms “and/or” used in one or more embodiments of the present specification refer to and include any or all possible combinations related to one or more listed items.

It should be understood that although various information may be described using terms such as first, second, etc. in one or more embodiments of the present specification, such information should not be limited to these terms. These terms are only used to distinguish information of the same type from each other. For example, without departing from the scope of one or more embodiments of the present specification, the first may also be referred to as the second, and similarly, the second may also be referred to as the first. Depending on the context, the word “if” used herein can be interpreted as “when” or “at the time that . . . ” or “in response to determining . . . ”.

Firstly, explanation will be made to the terminologies involved in one or more embodiments of the present specification.

Kubernetes: it is abbreviated as K8s which is an abbreviation formed by using 8 instead of the middle 8 characters “ubernete” in its name. K8s is an open-source application for managing containerized applications on multiple hosts in the cloud platform. It supports automatic deployment, large-scale scalability, and application containerization management. In kubernetes, we can create multiple containers, run one application instance in each container, and then manage, discover, and access this group of application instances through built-in load balancing strategy.

Apiserver: it is configured to expose a kubernetes API. Any resource request/call operation is carried out through the interface provided by the apiserver. Regarding the apiserver, please refer to the construction of high availability clusters.

Appmaster: it is responsible for running an entire task, including resource application, reception of scheduling results, and transmission of the task, etc.

Scheduler: it monitors newly created tasks that are not assigned to machine nodes and selects a machine node for a task.

In the present specification, a resource scheduling system is provided, and the present specification simultaneously involves an information processing system, a resource scheduling method, an information processing method, a computing device and a computer readable storage medium, which will be detailedly described one by one in following embodiments.

In a kubernetes framework, prior arts typically are: a task manager (appmaster) submitting a task processing request to a scheduler (scheduler) through an interface program (apiserver): after monitoring the task processing request through the interface program, the scheduler generating a resource scheduling result for it, the scheduler sending through the interface program the resource scheduling result to the task processor submitting the task processing request: a machine node receiving a resource scheduling event corresponding to the task processing request through the interface program, the task processor receiving the resource scheduling result corresponding to the task processing request through the interface program: and the machine node executing task processing according to the resource scheduling result. However, in order to ensure the order of task processing requests received, the interface program stores respective task processing requests and sends the task processing requests in series to the scheduler. This method can easily cause request accumulation and affect the resource scheduling efficiency.

A resource scheduling system provided in one embodiment of the present specification is based on the Kubernetes framework and improves the Kubernetes framework, where the scheduler directly executes information interactions with the resource processing node and the task processor, therefore, the possibility of request accumulation is reduced and the resource scheduling efficiency is improved. In this embodiment, the scheduler executing resource scheduling is used as an example, to describe the process of resource scheduling processing by the resource scheduling system. Correspondingly, for other resource scheduling schemes, reference can be made to the corresponding description in this embodiment, which will not be elaborated too much here.

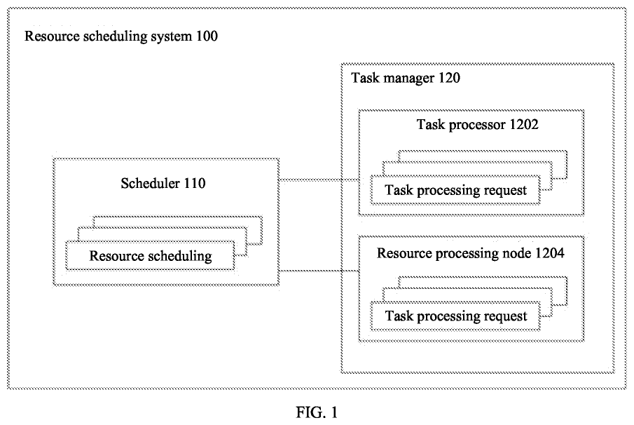

FIG. 1 shows a schematic structure diagram of a resource scheduling system provided in an embodiment of the present specification. The resource scheduling system 100 includes a scheduler 110 and a task manager 120, where the task manager 120 includes a task processor 1202 and a resource processing node 1204, where:

the task processor 1202 is configured to: receive a task processing request submitted for a task to be processed; and create, based on the task processing request, a resource acquiring request and send same to the scheduler 110;

the resource processing node 1204 is configured to: receive the task processing request: and create, based on the task processing request, schedulable resource information and send same to the scheduler 110;

the scheduler 110 is configured to: execute, according to the resource acquiring request and the schedulable resource information, resource scheduling on the task to be processed, to obtain a resource scheduling result: and send the resource scheduling result to the resource processing node 1204 and the task processor 1202.

Specifically, the task to be processed refers to an operation task that a client submits to the resource scheduling system for processing: the task processing request refers to computer instructions sent by a client to the task processor 1202, used for requesting for a resource to process a current operation task: the task processor 1202 is configured to receive the task to be processed, and request, according to the task to be processed, the scheduler 110 to allocate a resource required for executing the task to be processed, the task processor is appmaster in the Kubernetes framework: the resource acquiring request refers to computer instructions sent by the task processor 1202 to the scheduler 110 that are used for requesting a resource: the resource processing node 1204 is configured to receive the task to be processed and send relevant information of currently available resources to the scheduler 110, a scheduler in the Kubernetes framework is the scheduler: the schedulable resource information refers to relevant information of available resources currently available for the scheduler 110 to execute the resource scheduling: the scheduler 110 is configured to implement coordination, allocation, and recycling of resources in the resource scheduling system, and to analyze and match resources reasonably and effectively according to specific scheduling algorithms and strategies, in order to make more reasonable and full use of resources: the scheduler 110 operates as a separate program, and continuously receives resource acquiring requests from the task processor 1202 and schedulable resource information from the resource processing node 1204 after startup, provides feedback on the received resource acquiring requests and schedulable resource information, and sends the feedback results to the task processor 1202 and the resource processing node 1204, to complete the resource scheduling: the task manager includes the task processor and the resource processing node: the resource scheduling is the process in which the scheduler 110 determines the feedback results based on the received resource acquiring requests and schedulable resource information: the resource scheduling result is the feedback result of the scheduler 110.

Based on this, after receiving the task processing request submitted for the task to be processed, the task processor 1202 creates, based on the received task processing request, the resource acquiring request and sends the resource acquiring request to the scheduler 110: after receiving the task processing request, the resource processing node 1204 creates the schedulable resource information based on the task processing request, and sends the schedulable resource information to the scheduler 110,; after receiving the resource acquiring request and the schedulable resource information, the scheduler 110 executes resource scheduling on the task to be processed, to obtain the resource scheduling result, and sends the resource scheduling result respectively to the resource processing node 1204 and the task processor 1202.

In summary, the resource acquiring request and the schedulable resource information are respectively sent by the task processor and the resource processing node to the scheduler directly: thus shorting the waiting time for the scheduler to obtain the resource acquiring request and the schedulable resource information, and increasing the feedback speed of the task processing request.

Furthermore, after the task processor 1202 and the resource processing node 1204 receive the resource scheduling result fed back by the scheduler, the task to be processed can be processed according to the resource scheduling result. In this embodiment, the task processor 1202 is further configured to: receive the resource scheduling result, and send, based on the resource scheduling result, the task to be processed to the resource processing node 1204; the resource processing node 1204 is further configured to: receive the resource scheduling result and the task to be processed, determine, according to the resource scheduling result, a target resource corresponding to the task to be processed, and use the target resource to execute the task to be processed.

Specifically, the target resource refers to a resource that is determined by the task processor 1202 according to the received resource scheduling result, and that is used for executing the task to be processed; after the task processor 1202 sends the task to be processed to the resource processing node 1204 according to the resource scheduling result, the resource processing node 1204 can use a resource matched with the task to be processed to execute task processing.

Based on this, after the task processor 1202 receives the resource scheduling result sent by the scheduler, the task to be processed that is stored in the task processor 1202 is sent, based on the received the resource scheduling result, to the resource processing node 1204 to be executed. The resource processing node 1204 receives the resource scheduling result from the scheduler, simultaneously receives the task to be processed from the task processor 1202, determines, according to the received resource scheduling result from the scheduler, information corresponding to the target resource in the reported schedulable resource information, and uses the target resource to execute the task to be processed.

Furthermore, after the resource processing node 1204 completes the execution of the task to be processed, in order to improve resource utilization, the target resource for executing the task to be processed can be released, used for subsequent task processing. In this embodiment, the task processor 1202 is further configured to, under a situation of monitoring that the execution of the task to be processed is completed, send task execution completed information corresponding to the task to be processed to the scheduler 110.

The scheduler 110 is further configured to: create, based on the task execution completed information, a resource release request: and send the resource release request to the resource processing node 1204. The resource processing node 1204 is further configured to: receive the resource release request: and release the target resource according to the resource release request.

Specifically, the task execution completed information refers to information monitored by the task processor 1202 after the resource processing node 1204 completes the execution of the task to be processed, and indicates that the task to be processed is completed: the resource release request refers to computer instructions sent by the scheduler to the resource processing node 1204 after the resource processing node 1204 completes the execution of the task to be processed, used for informing the resource processing node 1204 to release the resource occupied when executing the task to be processed.

Based on this, after the task processor 1202 sends the task to be processed to the resource processing node 1204 for processing, an execution situation of the task to be processed of the resource processing node 1204 is continuously monitored: under a situation where it is monitored that the execution of the task to be processed is completed, the task processor 1202 sends the task execution completed information corresponding to the task to be processed to the scheduler: when receiving the task execution completed information from the task processor 1202, the scheduler creates, based on the task execution completed information, the resource release request used for informing the resource processing node 1204 to release the target resource occupied when it executes the task to be processed. The scheduler sends the resource release request to the resource processing node 1204: after receiving the resource release request, the resource processing node 1204 releases, according to the resource release request, the target resource used for executing the task to be processed.

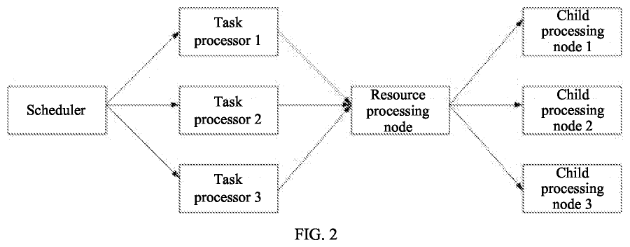

Take an example for illustration, as in the schematic diagram shown in FIG. 2, the scheduler can simultaneously receive resource acquiring requests from multiple task managers, each task manager has multiple tasks to be processed at the same time. The scheduler executes processing respectively based on the received multiple resource acquiring requests, determines a resource scheduling result corresponding to each resource acquiring request, and sends resource scheduling results respectively to the task managers 1-3: the resource scheduling results corresponding to the resource acquiring requests are sent by the task managers respectively to resource processing nodes 1-3, and then are sent by the resource processing nodes to child resource processing nodes for resource confirmation and task processing. After the task processing by the child resource processing nodes is completed, resource release requests are submitted to the scheduler, to release resources occupied during the task processing.

In summary, the scheduler implements the release of the target resource by sending the resource release request to the resource processing node: the target resource can also be used for executing other tasks after being released, thereby achieving the reuse of the target resource and improving the resource utilization efficiency.

Furthermore, when the task processor 1202 and the resource processing node 1204 respectively send the resource acquiring request and the schedulable resource information to the scheduler, problems about network, software, or hardware may occur at any time, leading to that the resource scheduling system would be malfunctioned, the scheduler needs to execute a malfunction recovery. In this embodiment, the scheduler 110 is further configured to, under a situation where the scheduler 110 is at a malfunction recovery state: create, according to the malfunction recovery state, an information acquiring request: send the information acquiring request to the resource processing node 1204 and the task processor 1202: the scheduler 110 is further configured to, under a situation of receiving malfunction recovery information associated with the information acquiring request, execute malfunction recovery processing based on the malfunction recovery information: the scheduler 110 is further configured to, under a situation of not receiving the malfunction recovery information, send the resource scheduling result to the resource processing node 1204 and the task processor 1202.

Specifically, the malfunction recovery state refers to a state in which a computer program executes network recovery and problem repairing after failed information transmission or communication interruption due to network restarting, process restarting, and issues of computer hardware/software, etc.: the information acquiring request refers to computer instructions that the scheduler needs to send to the task processor 1202 and the resource processing node 1204 after the scheduler is malfunctioned, used for notifying the task processor 1202 and the resource processing node 1204 to report the resource scheduling result to the scheduler: the malfunction recovery information is the resource scheduling result reported by the task processor 1202 and the resource processing node 1204 to the scheduler: the malfunction recovery processing refers to a process in which the scheduler adapts a malfunction processing strategy to repair a malfunction, to recover it to a normal status.

Based on this, when the scheduler sends the resource scheduling result to the resource processing node 1204 and the task processor 1202, under a situation where the scheduler is malfunctioned and is at the malfunction recovery state, in order to achieve a malfunction recovery, the scheduler creates the information acquiring request according to the current malfunction recovery state, and sends the information acquiring request to the resource processing node 1204 and the task processor 1202: the resource processing node 1204 and the task processor 1202 determine the malfunction recovery information according to the received information acquiring request, and send the malfunction recovery information to the scheduler: under a situation of receiving the malfunction recovery information, the scheduler executes malfunction recovery processing according to the malfunction recovery information: under a situation of not receiving the malfunction recovery information, the scheduler sends the resource scheduling result respectively to the resource processing node 1204 and the task processor 1202.

In summary, under the situation where the scheduler is malfunctioned, the scheduler immediately sends the information acquiring request to the resource processing node and the task processor, for receiving the malfunction recovery information, uses the malfunction recovery information to execute a malfunction recovery, thereby executing unfinished resource scheduling operations, to ensure that resource scheduling is executed for each task processing request, and avoiding a situation where the scheduler receives the task processing requests but does not process them.

Furthermore, under the situation where the scheduler receives the malfunction recovery information, in order to execute the malfunction recovery accurately, it is also necessary to determine whether the received malfunction recovery information is from the task processor 1202 or the resource processing node 1204, and select corresponding malfunction recovery processing. In this embodiment, the scheduler 110 is further configured to: under a situation of receiving the malfunction recovery information fed back by the resource processing node 1204, determine a target resource scheduling result according to the malfunction recovery information, and send the target resource scheduling result to the task processor 1202 and the resource processing node 1204: or under a situation of receiving the malfunction recovery information fed back by the task processor 1202, send scheduling result cancel information to the task processor 1202.

Specifically, the target resource scheduling result refers to a scheduling result determined for the malfunction recovery information subsequent to resource re-scheduling, after the scheduler receives the malfunction recovery information fed back by the resource processing node 1204.

Based on this, under the situation where the scheduler receives the malfunction recovery information fed back by the resource processing node 1204, it means that before the scheduler is malfunctioned, the resource processing node 1204 has determined a corresponding resource according to the resource scheduling result: after the scheduler is malfunctioned, the scheduler then determines the target resource scheduling result based on the received malfunction recovery information, and sends the target resource scheduling result respectively to the task processor 1202 and the resource processing node 1204, for the task processor 1202 and the resource processing node 1204 to process the task to be processed. When the malfunction recovery information received by the scheduler is from the task processor 1202, it means that before the scheduler is malfunctioned, the resource processing node 1204 does not receive the resource scheduling result, the scheduler immediately sends the scheduling result cancel information to the task processor 1202, used for notifying the task processor 1202 to cancel the resource scheduling result received before the scheduler is malfunctioned.

In summary, the scheduler adopts different malfunction recovery methods correspondingly by determining that the received malfunction recovery information comes from the task processor or the resource processing node, to achieve flexible malfunction recoveries.

Furthermore, when the scheduler waits for the task processor 1202 and the resource processing node 1204 to report the malfunction recovery information, considering issues of resource utilization, it is necessary to preset a fixed waiting time interval for the scheduler. If the waiting time exceeds the waiting time interval, the scheduler will not continue to wait for the task processor 1202 and the resource processing node 1204 to report the malfunction recovery information. In this embodiment, the scheduler 110 is further configured to: determine whether the malfunction recovery information is received within a preset time interval: if yes, perform the step of executing the malfunction recovery processing based on the malfunction recovery information;

if no, send the resource result cancel information to the resource processing node 1204 and the task processor 1202.

Specifically, the time interval refers to a time range preset for the scheduler, the scheduler waits for the task processor 1202 and the resource processing node 1204 to report the malfunction recovery information during the time range: if the waiting time of the scheduler exceeds this time range, the scheduler will not continue to wait. The scheduling result cancel information refers to information sent to the task processor 1202 and the resource processing node 1204 after the waiting time of the scheduler exceeds the preset time interval, used for notifying the task processor 1202 and the resource processing node 1204 that the scheduling result received currently by the task processor 1202 and the resource processing node 1204 is unavailable.

Based on this, when the scheduler waits for the task processor 1202 and the resource processing node 1204 to report the malfunction recovery information, a time interval of a fixed range is preset, the scheduler waits for the task processor 1202 and the resource processing node 1204 to report the malfunction recovery information during this time interval; if the malfunction recovery information is received during this time interval, the scheduler executes the malfunction recovery processing: if the malfunction recovery information is not received during this time interval, the scheduler sends the scheduling result cancel information to the task processor 1202 and the resource processing node 1204, used for notifying the task processor 1202 and the resource processing node 1204 to cancel the received resource scheduling result, so that the task processor 1202 and the resource processing node 1204 subsequently re-sends a resource acquiring request to the scheduler according to the task to be processed.

Take an example for illustration, when executing resource scheduling in the k8s framework, if the scheduler is malfunctioned due to network or other reasons and is restarted, the scheduler sends a request to AppMaster and Node, used for notifying AppMaster and Node to report the resource information received from the scheduler. When AppMaster and Node are not restarted, the scheduler, after receiving the resource information reported by the AppMaster and Node, restarts according to the received resource information: if only the resource information reported by AppMaster is received, but the resource information reported by Node is not received, it means the scheduler successfully sends the resource scheduling information to the AppMaster before the scheduler is malfunctioned, but fails to send the resource scheduling information to Node: after the malfunction is recovered, the scheduler sends cancel information to AppMaster to cancel the resource scheduling information received by AppMaster: if the resource information reported by Node is received, but the resource information reported by the AppMaster is not received, it means that, the scheduler successfully sends the resource scheduling information to Node before a malfunction occurs but fails to send the resource scheduling information to AppMaster: after the malfunction is recovered, the scheduler sends the resource scheduling information to AppMaster. When AppMaster and Node are also restarted, the scheduler waits for receiving the resource information reported by AppMaster and Node within the preset time range: if the resource information reported by AppMaster and Node is still not received after the time range is exceeded, after the malfunction is recovered, the scheduler will notify AppMaster and Node to cancel the reported resource information even if AppMaster and Node report the resource scheduling information.

In summary, by presenting the waiting time interval of the scheduler, the scheduler is enabled to wait within a fixed time interval, thereby avoiding resource waste caused by the scheduler waiting for a long time to receive the malfunction recovery information: the task processor and the resource processing node can also improve the processing efficiency of the task to be processed, according to the feedback from the scheduler.

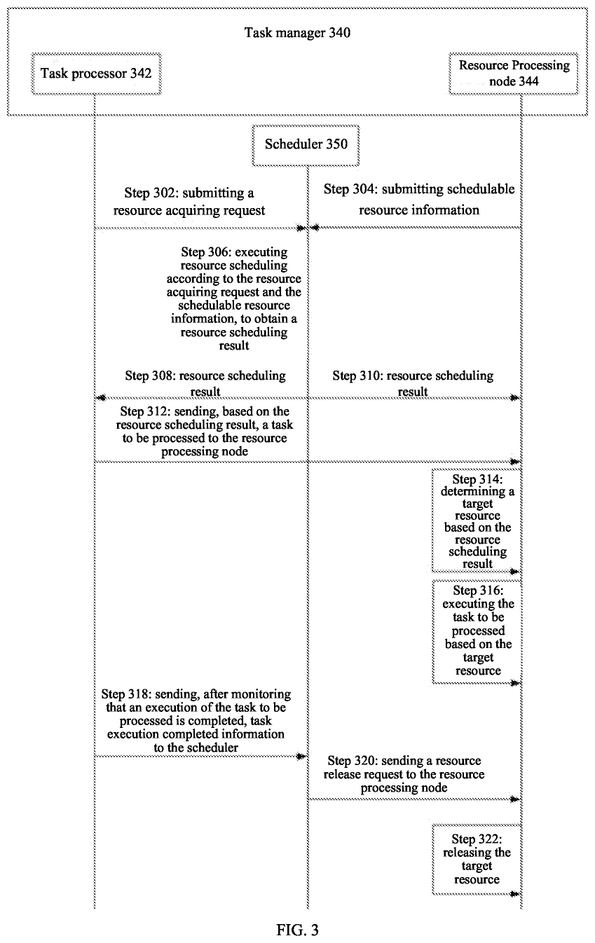

FIG. 3 shows a schematic interaction diagram of a resource scheduling system provided in an embodiment of the present application, including a task manager 340 and a scheduler 350, where the task manager 340 includes a task processor 342 and a resource processing node 344, an interaction process of the resource scheduling system specifically includes following steps.

Step S302, the task processor submits a resource acquiring request to the scheduler.

Step S304, the resource processing node submits schedulable resource information to the scheduler.

Step S306, the scheduler executes, according to the resource acquiring request and the schedulable resource information, resource scheduling, to obtain a resource scheduling result.

Step S308, the scheduler sends the resource scheduling result to the task processor.

Step S310, the scheduler sends the resource scheduling result to the resource processing node.

Step S312, the task processor sends, based on the resource scheduling result, a task to be processed to the resource processing node.

Step S314, the resource processing node receives the resource scheduling result, and determines a target resource based on the resource scheduling result.

Step S316, the resource processing node receives the task to be processed, and executes, based on the target resource, the task to be processed.

Step S318, the task processor sends, after monitoring that an execution of the task to be processed is completed, task execution completed information to the scheduler.

Step S320, the scheduler sends, according to the task execution completed information, a resource release request to the resource processing node.

Step S322, the resource processing node releases the target resource.

In summary, the resource acquiring request and the schedulable resource information are respectively sent by the task processor and the resource processing node to the scheduler directly: thus shortening waiting time for the scheduler to obtain the resource acquiring request and the schedulable resource information, and increasing the feedback speed of the task processing request.

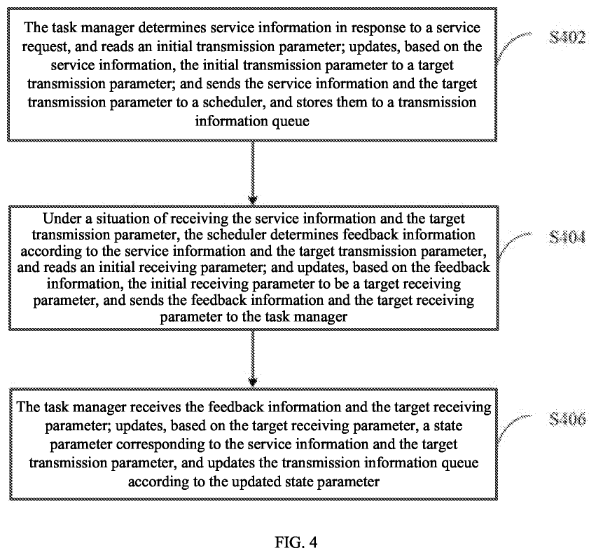

FIG. 4 shows a flowchart of an information processing method provided in an embodiment of the present specification. The information processing method is applied in the resource scheduling system mentioned above, and specifically includes the following steps.

Step S402, the task manager determines service information in response to a service request and reads an initial transmission parameter: updates, based on the service information, the initial transmission parameter to a target transmission parameter: and sends the service information and the target transmission parameter to a scheduler, and stores them to a transmission information queue.

Specifically, the service request refers to computer instructions received by the task processor, used for requesting, from the scheduler, for a resource to process a current operation task: the service information refers to resource requirement information corresponding to the service request, or information configured to be sent to an information receiver and be fed back by the information receiver: the initial transmission parameter refers to a current parameter value of the system before the task manager determines the service information: the target transmission parameter refers to a parameter value obtained from updating the initial transmission parameter, after the task manager determines a piece of service information to be sent to the scheduler: the transmission information queue refers to a linear table which is used to store the service information and the target transmission parameter.

Based on this, after receiving the service request, the task manager determines, in response to the received service request, the service information corresponding to the service request and reads an initial transmission parameter in a current state, updates, based on the service information that is determined to be sent to the scheduler, the initial transmission parameter in the current state, to update the initial transmission parameter to the target transmission parameter: then sends the service information and the target transmission parameter together to the scheduler, and simultaneously stores the service information and the target transmission parameter to the transmission information queue of the task manager, to facilitate retransmission of the service information and the target transmission parameter to the scheduler in case of a failure in sending the service information and the target transmission parameter subsequently.

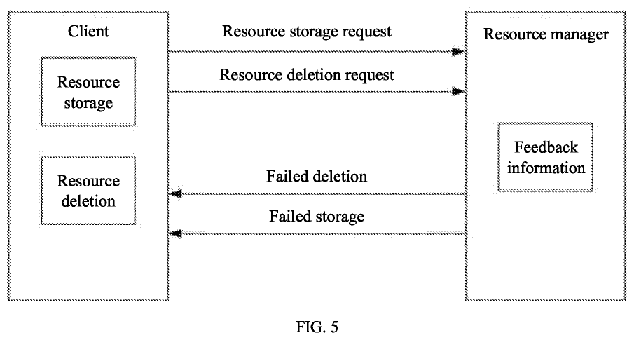

Take an example for illustration, as shown in FIG. 5, when a client has data storage and data deletion requirements, the client sends a resource storage request and a resource deletion request to the resource manager: simultaneously, stores the resource storage request and the resource deletion request as well as a corresponding transmission parameter into the transmission information queue, to facilitate that a state parameter and the target transmission parameter can be updated after feedback information fed back by the scheduler and the target transmission parameter are received subsequently.

Step S404, under a situation of receiving the service information and the target transmission parameter, the scheduler determines feedback information according to the service information and the target transmission parameter, and reads an initial receiving parameter: and updates, based on the feedback information, the initial receiving parameter to a target receiving parameter, and sends the feedback information and the target receiving parameter to the task manager.

Specifically, after the task manager mentioned above sends the service information and the target transmission parameter to the scheduler, the scheduler needs to send the feedback information to the task manager after receiving the service information and the target transmission parameter, and updates the initial receiving parameter, where the feedback information refers to information determined by the scheduler after receiving the service information and the target transmission parameter sent by the task manager: the initial receiving parameter is a current parameter value of the system before the scheduler serving as a receiver of information receives the service information: the target receiving parameter refers to a parameter value obtained from updating the initial receiving parameter, after the scheduler determines the feedback information.

Based on this, under the situation of receiving the service information and the target transmission parameter sent by the task manager, the scheduler determines, according to the received service information and target transmission parameter, the feedback information corresponding to the service information, and reads an initial receiving parameter corresponding to the scheduler in a current state: updates the initial receiving parameter according to the determined feedback information corresponding to the service information, to update the initial receiving parameter to a target receiving parameter: then sends the feedback information and the target receiving parameter that is obtained by updating the initial receiving parameter together to the task manager, and simultaneously stores the feedback information and the target receiving parameter together to the transmission information queue corresponding to the scheduler, to facilitate that the feedback information and the target receiving parameter are sent to the task manager again, in case of not receiving the service information sent by the task manager subsequently.

Furthermore, after the scheduler receives the service information and the target transmission parameter, before the feedback information is sent to the task manager, in order to improve the reliability of information transmission, it is also necessary to update the initial receiving parameter based on the feedback information: a specific implementation is as follows.

The scheduler reads the initial receiving parameter, and updates the initial receiving parameter to an intermediate receiving parameter: and updates, based on the feedback information, the intermediate receiving parameter to the target receiving parameter.

Specifically, the intermediate receiving parameter refers to a result obtained from updating the initial receiving parameter, after the scheduler receives the service information from the task manager, used for an indication of confirming, by the scheduler, reception of a piece of service information from the task manager.

Based on this, after the scheduler receives the service information and the target transmission parameter, the scheduler reads a current initial receiving parameter of the system: since a piece of service information is received, the initial receiving parameter is updated based on the target transmission parameter received together with the service information, to update the initial receiving parameter to the intermediate receiving parameter: after confirming the feedback information to be sent to the task manager, the scheduler updates the intermediate receiving parameter based on the feedback information, to update the intermediate receiving parameter to the target receiving parameter.

In summary, with the method for determining the intermediate receiving parameter based on the target transmission parameter, updating of the initial receiving parameter to the intermediate receiving parameter is implemented, which improves the accuracy of updating the initial receiving parameter: at the same time, when the scheduler confirms the service information and the task manager confirms the feedback information, the initial transmission parameter and the intermediate receiving parameter are updated respectively, thereby improving the reliability of information transmission.

Furthermore, after the task manager determines the service information, in order to improve the reliability of information transmission and record the order of the information transmission, it is also necessary to update the initial transmission parameter based on the service information, and after the scheduler receives the target transmission parameter, to update the initial receiving parameter based on the target transmission parameter: a specific implementation is as follows.

The task manager updates, based on the service information, a transmission information parameter contained in the initial transmission parameter, to obtain the target transmission parameter: the scheduler is further configured to update, according to a transmission information parameter contained in the target transmission parameter, a first confirmation parameter contained in the initial receiving parameter, to obtain the intermediate receiving parameter.

Specifically, the transmission information parameter refers to a parameter contained in the initial transmission parameter, the updated transmission information parameter (i.e. the transmission information parameter contained in the target transmission parameter) is used for indicating that the task manager sends the service information to the scheduler; the first confirmation parameter refers to a parameter contained in the initial receiving parameter, the updated first confirmation parameter is used for indicating that the scheduler receives the service information sent by the task manager and the initial transmission parameter containing the updated transmission information parameter (i.e. the target transmission parameter).

Based on this, after the task manager determines the service information, the transmission information parameter contained in the initial transmission parameter is updated based on the determined service information, to obtain the target transmission parameter, and the service information and the target transmission parameter together are sent to the scheduler. After receiving the service information and the target transmission parameter sent by the task manager, the scheduler updates, according to the transmission information parameter contained in the received target transmission parameter, the first confirmation parameter included in the initial receiving parameter, to obtain the intermediate receiving parameter.

In summary, by updating the initial transmission parameter according to the determined service information and updating the initial receiving parameter according to the transmission information parameter, the accuracy of updating the initial transmission parameter and the initial receiving parameter is improved.

Furthermore, after the scheduler updates, according to the target transmission parameter, the initial receiving parameter to the intermediate receiving parameter, before the scheduler sends the feedback information, in order to improve the reliability of information transmission and record the order of the information transmission, it is also necessary to update the intermediate receiving parameter: a specific implementation is as follows.

The scheduler updates, according to the feedback information and the intermediate receiving parameter, a receiving information parameter included in the intermediate receiving parameter, to obtain the target receiving parameter.

Specifically, the receiving information parameter refers to a parameter included in the intermediate receiving parameter, used for indicating that the scheduler receives the service information and the target transmission parameter sent by the task manager and determines the feedback information: and after the feedback information to be sent to the task manager is determined, the receiving information parameter is updated.

Based on this, after the scheduler receives the service information and the target transmission parameter sent by the task manager, the feedback information to be fed back to the task manager is determined based on the received service information: the scheduler updates, according to the determined feedback information and the intermediate receiving parameter, the receiving information parameter contained in the intermediate receiving parameter of the scheduler, to obtain the target receiving parameter.

In summary, by updating the intermediate receiving parameter to the target receiving parameter according to the determined feedback information, the accuracy of updating the intermediate receiving parameter is improved.

Furthermore, after the task manager receives the feedback information and the target receiving parameter of the scheduler, it means that the task manager receives a feedback result from the scheduler for the service information, i.e. a reply by the scheduler to the service information: at this time, it is also necessary to delete the service information and the target transmission parameter stored in the transmission information queue together, and update the target transmission parameter: a specific implementation is as follows.

Under a situation of receiving the target receiving parameter, the task manager updates, based on the receiving information parameter contained in the target receiving parameter, a second confirmation parameter contained in the target transmission parameter and the state parameter: deletes, based on an updated state parameter, the service information and the target transmission parameter stored in the transmission information queue.

Specifically, the second confirmation parameter refers to a parameter contained in the target transmission parameter, used for indicating that the task manager receives the feedback information sent by the scheduler for the service information: the state parameter specifically refers to a logical value with two options: TRUE and FALSE, 0 and 1, used for indicating whether feedback information is received after the task manager or the scheduler sends information, if yes, the state parameter is TRUE, if no, the state parameter is FALSE.

Based on this, under the situation where the task manager receives the target receiving parameter sent by the scheduler, the second confirmation parameter contained in the target transmission parameter is updated based on the receiving information parameter contained in the received target receiving parameter, and simultaneously the state parameter of the task manager is updated: after the state parameter is updated, the service information and the target transmission parameter stored in the transmission information queue of the task manager are deleted, to facilitate the release of storage space occupied by the service information and the target transmission parameter.

Take an example for illustration, as shown in FIG. 5, when the client sends the resource storage request and the resource deletion request to the resource manager, the resource storage request and the resource deletion request as well as a corresponding transmission parameter are simultaneously stored in the transmission information queue: when the resource manager receives the resource storage request and the resource deletion request, a receiving parameter corresponding to the resource manager is updated, simultaneously determines feedback information on failed storage and failed deletion, sends the feedback information to the client, simultaneously updates the receiving parameter corresponding to the resource manager: after the client receives the feedback information, the transmission parameter is updated again, the state parameter is updated simultaneously, to indicate that a reply from the resource manager is received.

In addition, an interaction process between any two nodes in the resource scheduling system can be implemented by the information processing method provided by this embodiment, for interaction processes among other nodes, reference can be made to the same or corresponding description content in this embodiment, which will not be elaborated too much here.

In summary, after the task manager receives the feedback information and the target receiving parameter, the second confirmation parameter and the status parameter are updated, and the service information and the target transmission parameter stored in the transmission information queue are deleted, which improves the reliability of information transmission and also improves the utilization of storage space.

Step S406, the task manager receives the feedback information and the target receiving parameter: updates, based on the target receiving parameter, a state parameter corresponding to the service information and the target transmission parameter, and updates the transmission information queue according to the updated state parameter.

Specifically, in the above description, after the scheduler feeds back the feedback information and sends the target receiving parameter, the task manager can update, after receiving the feedback information and the target receiving parameter, the state parameter corresponding to the service information and the target transmission parameter, where the state parameter is used to indicate whether the feedback information of the scheduler is received after the task manager sends the service information, the state parameter is represented by a Boolean value, that is, if so, the state parameter is TRUE, if not, the state parameter is FALSE.

Based on this, after receiving the feedback information and the target receiving parameter from the scheduler, the task manager updates, according to the received target receiving parameter, the state parameter corresponding to the service information and the target transmission parameter, and updates, according to an updated state parameter, the transmission information queue of the task manager, i.e. deletes the service information stored in the transmission information queue, thereby saving space of the transmission information queue. Furthermore, considering that during information interactions between the task manager and the scheduler, due to network reasons and various reasons, there may be a situation where the task manager sends information to the scheduler but the scheduler does not receive the information, or a situation where the scheduler sends information but the task manager does not receive the information, it is also necessary for the task manager to send the service information and the target transmission parameter to the scheduler again: a specific implementation is as follows.

Under a situation of not receiving the feedback information, the task manager sends, according to a preset information transmission rule, the service information and the target transmission parameter stored in the transmission information queue to the scheduler.

Specifically, the information transmission rule refers to rules and guidelines preset for the transmission information queue. In this embodiment, the information transmission rule may be that the service information and the target transmission parameter stored in the transmission information queue are sent to the scheduler within a preset time range, by a time cycle of fixed intervals.

Based on this, after the task manager sends the service information and the target transmission parameter to the scheduler, under a situation where the task manager does not receive the feedback information sent by the scheduler, the task manager sends the service information and the target transmission parameter stored in the transmission information queue to the scheduler within the preset time range, according to fixed time intervals, and waits for receiving the feedback information of the scheduler.

Correspondingly, under a situation where the scheduler does not receive service information sent again by the task manager after sending the feedback information to the task manager, the scheduler sends the feedback information and the target receiving parameter stored in the receiving information queue to the task manager within the preset time range, according to fixed time intervals, and waits for receiving feedback information of the task manager.

Following the above example, under a situation where the client does not receive feedback information after sending the resource storage request and the resource deletion request to the resource manager, the client sends the resource storage request and the resource deletion request stored in the transmission information queue to the resource manager within a preset time range, according to fixed time intervals, and waits for receiving feedback information of the resource manager.

In summary, under a situation where the task manager does not receive the feedback information, by re-sending the service information and the target transmission parameter to the scheduler, even if the scheduler does not receive the service information and the target transmission parameter due to some factors, such as network factors, the service information and the target transmission parameter can also be received under a situation of resending by the task manager, thereby improving the reliability of information transmission.

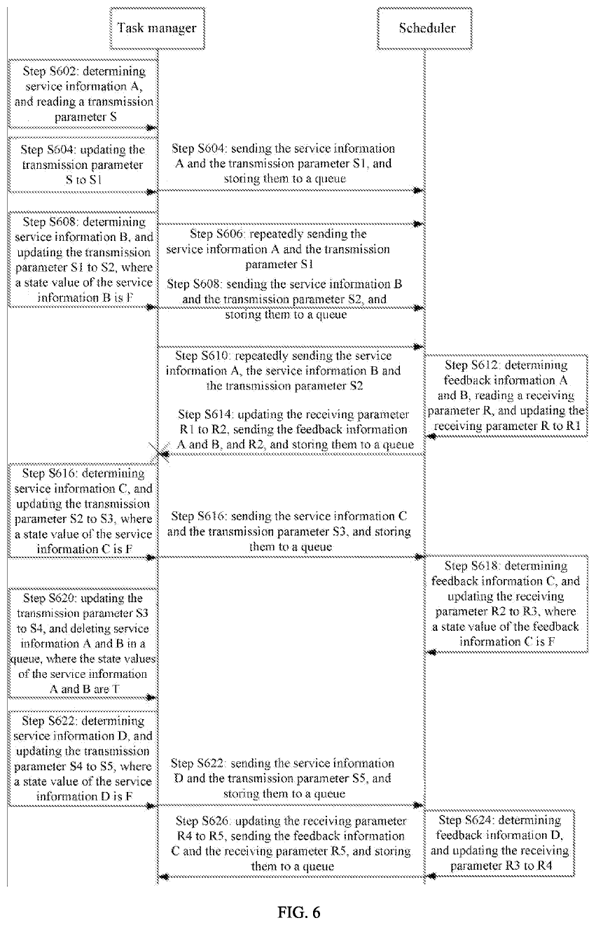

FIG. 6 shows a schematic interaction diagram of an information processing method provided in an embodiment of the present application, specifically including the following steps.

Step S602, a task manager determines service information A based on a service request, and reads a transmission parameter S={sendId_s=0, ackId_s=0}.

Step S604, the task manager updates the transmission parameter S based on the service information A, to obtain a transmission parameter S1={sendId_s=1, ackId_s=0}, sends the service information A and the transmission parameter S1 to a scheduler, and stores them to a sender information queue: where a state value of the service information A is F.

Step S606, under a situation where there is a network malfunction, the task manager repeatedly sends the service information A and the transmission parameter S1 to the scheduler within a preset time.

Step S608, the task manager updates, based on the service information B, the transmission parameter S1 outside the preset time, to obtain a transmission parameter S2={sendId_s=2, ackId_s=0}, sends the service information B and the transmission parameter S2 to the scheduler, and stores them to the sender information queue: where a state value of the service information B is F.

Step S610, under a situation of not receiving feedback information within a preset time, the task manager repeatedly sends the service information A, the service information B, and the transmission parameter S2 to the scheduler.

Step S612, under a situation of receiving the service information A, the service information B, and the transmission parameter S2, the scheduler determines feedback information A corresponding to the service information A and feedback information B corresponding to the service information B based on the service information A, the service information B and the transmission parameter S2, reads a receiving parameter R={sendId_r=0, ackId_r=0}, and updates the receiving parameter R based on the transmission parameter S2, to obtain a receiving parameter R1={sendId_r=0, ackId_r=2}, where states values of the feedback information A and the feedback information B are both F.

Step S614, the scheduler updates the receiving parameter R1 to a receiving parameter R2={sendId_r=2, ackId_r=2}, sends the feedback information A, the feedback information B and the receiving parameter R2 to the task manager, and stores them to a receiver information queue, where the states values of the feedback information A and the feedback information B are both F.

Step S616, under a situation of not receiving the feedback information A and the feedback information B due to an issue of a network malfunction, the task manager updates the transmission parameter S2 based on the service information C, to obtain a transmission parameter S3={sendId_s=3, ackId_s=0}, sends the service information C and the transmission parameter S3 to the scheduler, and stores them to the sender information queue: where a state value of the service information C is F.

Step S618, the scheduler receives the service information C and the transmission parameter S3 after the network malfunction is solved, determines feedback information C corresponding to the service information C, updates the receiving parameter R2 based on the transmission parameter S3, to obtain a receiving parameter R3={sendId_r=2, ackId_r=3}, where a state value of the feedback information C is F.

Step S620, the task manager receives the feedback information A, the feedback information B and the receiving parameter R2 after the network malfunction is solved: updates the transmission parameter S3 based on ackId_r=2 in the receiving parameter R2, to obtain a transmission parameter S4={sendId_s=3, ackId_s=2}: deletes the service information A and the service information B stored in the sender information queue, and simultaneously updates the state values of the service information A and the service information B to T.

Among them, step S618 and step S620 are executed simultaneously after the network malfunction is solved.

Step S622, the task manager updates the transmission parameter S4 based on service information D, to obtain a transmission parameter S5={sendId_s=4, ackId_s=2}, sends the service information D and the transmission parameter S5 to the scheduler, and stores them to the sender information queue: where a state value of the service information D is F.

Step S624, under a situation of receiving the service information D and the transmission parameter S5, the scheduler determines feedback information D corresponding to the service information D, updates the receiving parameter R3 based on the transmission parameter S5, to obtain a receiving parameter R4={sendId_r=2, ackId_r=4}.

Step S626, the scheduler updates the receiving parameter R4 to a receiving parameter R5={sendId_r=3, ackId_r=4}, sends the feedback information C and the receiving parameter R5 to the task manager, and stores them to the receiver information queue, where a state value of the feedback information C is F.

Among them, step S624 and step S626 are executed simultaneously: by analogy, until the interaction is completed.

In summary, while information interactions are executed between the task manager and the scheduler, the transmission parameters of the task manager and the receiving parameters of the scheduler are maintained, thereby protecting information reception from being out of order when multiple pieces of information transmitted between the task manager and the scheduler, and at the same time ensuring that every piece of information sent by the task manager or the scheduler is provided with feedback.

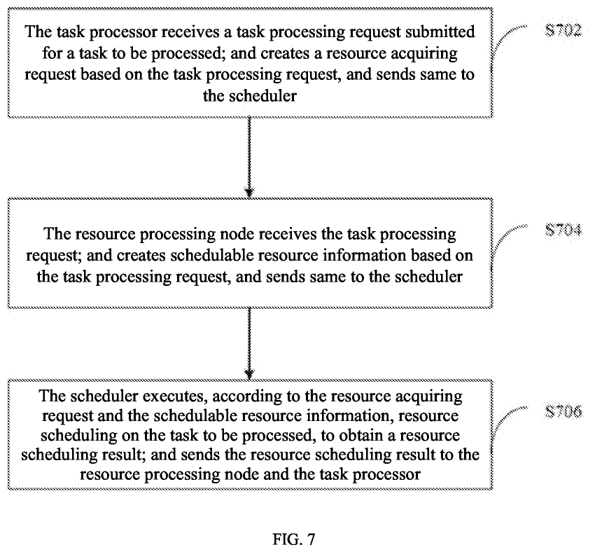

Corresponding to the system embodiments mentioned above, the present specification further provides a resource scheduling method, FIG. 7 shows a flowchart of a resource scheduling method provided in an embodiment of the present specification, specifically including following steps.

Step 702, the task processor receives a task processing request submitted for a task to be processed; and creates, based on the task processing request, a resource acquiring request and send same to the scheduler.

Step 704, the resource processing node receives the task processing request: and creates schedulable resource information based on the task processing request, and sends same to the scheduler.

Step 706, the scheduler executes, according to the resource acquiring request and the schedulable resource information, resource scheduling on the task to be processed, to obtain a resource scheduling result: and sends the resource scheduling result to the resource processing node and the task processor.

In an implementation of this embodiment, the resource scheduling method includes: under a situation where the scheduler is at a malfunction recovery state, the scheduler creating, according to the malfunction recovery state, an information acquiring request: sending the information acquiring request to the resource processing node and the task processor: under a situation of receiving malfunction recovery information associated with the information acquiring request, the scheduler executing malfunction recovery processing based on the malfunction recovery information: under a situation of not receiving the malfunction recovery information, the scheduler sending the resource scheduling result to the resource processing node and the task processor.

In an implementation of this embodiment, the resource scheduling method includes: under a situation of receiving the malfunction recovery information fed back by the resource processing node, the scheduler determining a target resource scheduling result according to the malfunction recovery information, and sending the target resource scheduling result to the task processor and the resource processing node: or, under a situation of receiving the malfunction recovery information fed back by the task manager, the scheduler sending scheduling result cancel information to the task manager.

In an implementation of this embodiment, the resource scheduling method includes:

the scheduler determining whether the malfunction recovery information is received within a preset time interval: if yes, performing the step of executing the malfunction recovery processing based on the malfunction recovery information: if no, sending the resource result cancel information to the resource processing node and the task processor.

In an implementation of this embodiment, the resource scheduling method includes: the task processor receiving the resource scheduling result, and sending, based on the resource scheduling result, the task to be processed to the resource processing node: the resource processing node receiving the resource scheduling result and the task to be processed, determining, according to the resource scheduling result, a target resource corresponding to the task to be processed, and using the target resource to execute the task to be processed.

In an implementation of this embodiment, the resource scheduling method includes: under a situation where the execution of the task to be processed is completed is monitored, the task processor sending task execution completed information corresponding to the task to be processed to the scheduler: the scheduler creating, based on the task execution completed information, a resource release request, and sending the resource release request to the resource processing node: the resource processing node receiving the resource release request, and releasing the target resource according to the resource release request.

The above description is schematic schemes of the resource scheduling method and the information processing method of the present embodiments. It should be noted that the technical solution of the resource scheduling method belongs to the same concept as the technical solution of the resource scheduling system mentioned above, and the technical solution of the information processing method belongs to the same concept as the technical solution of the information processing system mentioned above. Any details not described in detail in the technical solution of the resource scheduling method can be found in the description of the technical solution of the resource scheduling system mentioned above, any details not described in detail in the technical solution of the information processing method can be found in the description of the technical solution of the information processing system mentioned above.

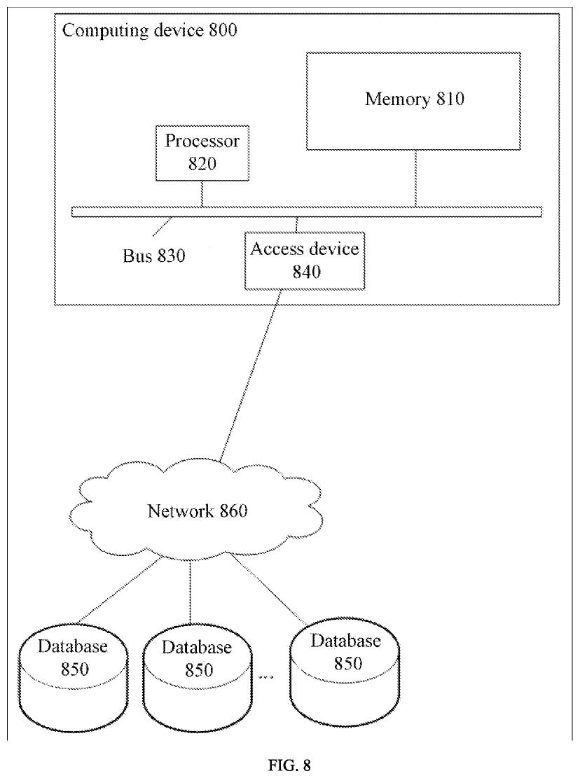

FIG. 8 shows a block diagram of a structure of a computing device 800 provided according to an embodiment of the present specification. Components of the computing device 800 include, but not limited to, a memory 810 and a processor 820. The processor 820 and the memory 810 are connected with each other through a bus 830. A database 850 is configured to store data.

The computing device 800 also includes an access device 840, the access device 840 enables the computing device 800 to communicate through one or more networks 860. Examples of these networks include Public Switched Telephone Network (PSTN), Local Area Network (LAN), Wide Area Network (WAN), Personal Area Network (PAN), or a combination of communication networks such as the Internet. The access device 840 may include one or more of any type of wired or wireless network interfaces (such as a Network Interface Card (NIC)), such as IEEE802.11 Wireless Local Area Network (WLAN) wireless interface,

Worldwide Interoperability for Microwave Access (Wi-MAX) interface, Ethernet interface, Universal Serial Bus (USB) interface, cellular network interface, Bluetooth interface, Near Field Communication (NFC) interface, and so on.

In an embodiment of the present specification, the components mentioned above of the computing device 800 and other components not shown in FIG. 8 may also be connected to each other, for example, through the bus. It should be understood that the block diagram of the structure of the computing device shown in FIG. 8 is only for illustrative purposes and not a limitation on the scope of the present specification. Those skilled in the art can add or replace other components as needed.

The computing device 800 can be any type of stationary or mobile computing device, including a mobile computer or mobile computing device (such as a tablet computer, a personal digital assistant, a laptop computer, a notebook computer, a netbook, etc.), a mobile phone (such as a smartphone), a wearable computing device (such as a smartwatch, smart glasses, etc.), or other types of mobile devices, or a static computing device such as a desktop computer or PC. The computing device 800 may also be a mobile or stationary server.

The processor 820 is configured to execute the following computer executable instructions, when the computer executable instructions are executed by the processor, steps of the methods mentioned above are implemented.

The above descriptions are schematic schemes of the computing device of this embodiment. It should be noted that the technical solution of the computing device belongs to the same concept as the technical solution of the methods mentioned above, any details not described in detail in the technical solution of the computing device can be found in the description of the technical solution of the methods mentioned above.

An embodiment of the present specification further provides a computer readable storage medium, where the computer readable storage medium stores computer executable instructions, when the computer executable instructions are executed by a processor, steps of the methods mentioned above are implemented.

The above description is a schematic scheme of a computer readable storage medium of this embodiment. It should be noted that the technical solution of the storage medium belongs to the same concept as the technical solution of the methods mentioned above, any details not described in detail in the technical solution of the storage medium can be found in the description of the technical solution of the methods mentioned above.

An embodiment of the present specification further provides a computer program, where when the computer program is executed in a computer, the computer is enabled to execute steps of the methods mentioned above.

The above description is a schematic scheme of a computer program of this embodiment. It should be noted that the technical solution of the computer program belongs to the same concept as the technical solution of the methods mentioned above, any details not described in detail in the technical solution of the computer program can be found in the description of the technical solution of the methods mentioned above.

Description is made above to specific embodiments of the present specification. Other embodiments are within the scope of the appended claims. In some cases, actions or steps recorded in the claims may be executed in an order different from that in the embodiments and still achieve the desired results. In addition, the process depicted in the drawings does not necessarily require a specific or continuous order to achieve the desired results. In some implementations, multitasking processing and parallel processing are also possible or may be advantageous.

The computer instructions include computer program codes, the computer program codes may be in the form of source codes, object codes, executable files, or in some intermediate forms. The computer readable medium may include: any entity or apparatus capable of carrying the computer program codes, recording medium, USB flash drive, portable hard drive, magnetic disc, optical disc, computer memory, read-only memory (ROM, Read-Only Memory), random access memory (RAM, Random Access Memory), electrical carrier signal, telecommunication signal, and software distribution medium, etc. It should be noted that content contained in the computer readable medium can be appropriately added or cut according to the requirements of legislation and patent practice in the jurisdiction. For example, in some jurisdictions, according to the legislation and patent practice, the computer readable medium does not include electric carrier signals and telecommunication signals.

It should be noted that for the convenience of description, the aforementioned embodiments of each method are all expressed as a series of action combinations. However, those skilled in the art should be aware that the embodiments of the present specification are not limited by the described order of actions, as according to the embodiments of the present specification, certain steps can be performed in other orders or simultaneously. Secondly, order should also be aware that the embodiments described in the specification are all exemplary embodiments, and the actions and modules involved may not necessarily be necessary for the embodiments in the present specification.

In the embodiments mentioned above, the description of respective embodiment has its own emphasis. For parts without detailed description in one embodiment, reference can be made to the relevant descriptions of other embodiments.

The embodiments of the present specification disclosed above are only intended to assist in elaborating the present specification. The embodiments and implementations do not fully describe all the details, nor do they limit the invention to only the specific implementations described. Obviously, according to the content of the embodiments in the present specification, various modifications and changes can be made. The present specification selects and specifically describes these embodiments in order to better explain the principles and practical applications of the embodiments in the present specification, so that those skilled in the art can understand and utilize the present specification well. The present specification is limited only by the claims and their entire scope and equivalents.

1. A resource scheduling system, comprising:
a scheduler and a task manager, wherein the task manager comprises a task processor and a resource processing node;
the task processor is configured to: receive a task processing request submitted for a task to be processed; and create, based on the task processing request, a resource acquiring request and send the resource acquiring request to the scheduler;
the resource processing node is configured to: receive the task processing request; and create, based on the task processing request, schedulable resource information and send the schedulable resource information to the scheduler;
the scheduler is configured to execute, according to the resource acquiring request and the schedulable resource information, resource scheduling on the task to be processed, to obtain a resource scheduling result; and send the resource scheduling result to the resource processing node and the task processor.

2. The resource scheduling system according to claim 1, wherein the scheduler is further configured to, under a situation where the scheduler is at a malfunction recovery state: create, according to the malfunction recovery state, an information acquiring request; send the information acquiring request to the resource processing node and the task processor;
the scheduler is further configured to, under a situation of receiving malfunction recovery information associated with the information acquiring request, execute malfunction recovery processing based on the malfunction recovery information;
the scheduler is further configured to, under a situation of not receiving the malfunction recovery information, send the resource scheduling result to the resource processing node and the task processor.

3. The resource scheduling system according to claim 2, wherein the scheduler is further configured to: under a situation of receiving the malfunction recovery information fed back by the resource processing node, determine a target resource scheduling result according to the malfunction recovery information, and send the target resource scheduling result to the task processor and the resource processing node; or,
under a situation of receiving the malfunction recovery information fed back by the task processor, send scheduling result cancel information to the task processor.

4. The resource scheduling system according to claim 2, wherein the scheduler is further configured to: determine whether the malfunction recovery information is received within a preset time interval;
if yes, perform the step of executing the malfunction recovery processing based on the malfunction recovery information;
if no, send the resource result cancel information to the resource processing node and the task processor.

5. The resource scheduling system according to claim 1, wherein the task processor is further configured to: receive the resource scheduling result, and send, based on the resource scheduling result, the task to be processed to the resource processing node;
the resource processing node is further configured to: receive the resource scheduling result and the task to be processed, determine, according to the resource scheduling result, a target resource corresponding to the task to be processed, and use the target resource to execute the task to be processed.

6. The resource scheduling system according to claim 5, wherein the task processor is further configured to, under a situation of monitoring that an execution of the task to be processed is completed, send task execution completed information corresponding to the task to be processed to the scheduler;
the scheduler is further configured to: create, based on the task execution completed information, a resource release request, and send the resource release request to the resource processing node;
the resource processing node is further configured to: receive the resource release request, and release the target resource according to the resource release request.

7. An information processing method, applied in the resource scheduling system according to claim 1, comprising:
determining, by a task manager, service information in response to a service request, and reading an initial transmission parameter; updating, based on the service information, the initial transmission parameter to a target transmission parameter; and sending the service information and the target transmission parameter to a scheduler, and storing them to a transmission information queue;
determining, by the scheduler, feedback information according to the service information and the target transmission parameter under a situation of receiving the service information and the target transmission parameter, and reading an initial receiving parameter; and updating, based on the feedback information, the initial receiving parameter to a target receiving parameter, and sending the feedback information and the target receiving parameter to the task manager; and
receiving, by the task manager, the feedback information and the target receiving parameter; updating, based on the target receiving parameter, a state parameter corresponding to the service information and the target transmission parameter, and updating the transmission information queue according to the updated state parameter.

8. The information processing method according to claim 7, wherein the updating, based on the feedback information, the initial receiving parameter to the target receiving parameter comprises: updating, the initial receiving parameter to an intermediate receiving parameter; and updating, based on the feedback information, the intermediate receiving parameter to the target receiving parameter.

9. The information processing method according to claim 8, comprising: updating, based on the service information, a transmission information parameter contained in the initial transmission parameter, to obtain the target transmission parameter;
the updating, based on the feedback information, the intermediate receiving parameter to the target receiving parameter comprises: updating, according to a transmission information parameter contained in the target transmission parameter, a first confirmation parameter contained in the initial receiving parameter, to obtain the intermediate receiving parameter.

10. The information processing method according to claim 9, comprising: updating, by the scheduler, a receiving information parameter contained in the intermediate receiving parameter according to the feedback information and the intermediate receiving parameter, to obtain the target receiving parameter.

11. The information processing method according to claim 10, comprising: wherein
under a situation of receiving the target receiving parameter, updating, by the task manager, a second confirmation parameter contained in the target transmission parameter and the state parameter based on the receiving information parameter contained in the target receiving parameter; and
deleting, based on the updated state parameter, the service information and the target transmission parameter stored in the transmission information queue.

12. The information processing method according to claim 7, comprising: under a situation of not receiving the feedback information, ending, by the task manager, the service information and the target transmission parameter stored in the transmission information queue to the scheduler according to a preset information transmission rule.

13. A resource scheduling method, comprising:
receiving, by a task processor, a task processing request submitted for a task to be processed; and creating, based on the task processing request, a resource acquiring request and sending the resource acquiring request to a scheduler;
receiving, by a resource processing node, the task processing request; and creating, based on the task processing request, schedulable resource information and sending the schedulable resource information to the scheduler; and
executing, by the scheduler according to the resource acquiring request and the schedulable resource information, resource scheduling on the task to be processed, to obtain a resource scheduling result; and sending the resource scheduling result to the resource processing node and the task processor.

14. A computing device, comprising:
a memory and a processor;
wherein the memory is configured to store computer executable instructions, the processor is configured to execute the computer executable instructions, when the computer executable instructions are executed by the processor, steps of the method according to claim 7 are implemented.

15. A computer readable storage medium, storing computer executable instructions, wherein when the computer executable instructions are executed by a processor, steps of the method according to claim 7 are implemented.

16. The resource scheduling method according to claim 13, comprising:
under a situation where the scheduler is at a malfunction recovery state, creating, by the scheduler, an information acquiring request according to the malfunction recovery state; sending the information acquiring request to the resource processing node and the task processor;
under a situation of receiving malfunction recovery information associated with the information acquiring request, executing, by the scheduler, malfunction recovery processing based on the malfunction recovery information; and
under a situation of not receiving the malfunction recovery information, sending, by the scheduler, the resource scheduling result to the resource processing node and the task processor.

17. The resource scheduling method according to claim 16, comprising:
under a situation of receiving the malfunction recovery information fed back by the resource processing node, determining, by the scheduler, a target resource scheduling result according to the malfunction recovery information, and sending the target resource scheduling result to the task processor and the resource processing node; or
under a situation of receiving the malfunction recovery information fed back by a task manager, sending, by the scheduler, scheduling result cancel information to the task manager.

18. The resource scheduling method according to claim 16, comprising:
determining, by the scheduler, whether the malfunction recovery information is received within a preset time interval;
if yes, performing the step of executing the malfunction recovery processing based on the malfunction recovery information;
if no, sending the resource result cancel information to the resource processing node and the task processor.

19. The resource scheduling method according to claim 13, comprising:
receiving, by the task processor, the resource scheduling result, and sending, based on the resource scheduling result, the task to be processed to the resource processing node; receiving, by the resource processing node, the resource scheduling result and the task to be processed, determining, according to the resource scheduling result, a target resource corresponding to the task to be processed, and using the target resource to execute the task to be processed.

20. A computer readable storage medium, storing computer executable instructions, wherein when the computer executable instructions are executed by a processor, following steps are implemented:
receiving, by a task processor, a task processing request submitted for a task to be processed;
and creating, based on the task processing request, a resource acquiring request and sending the resource acquiring request to a scheduler;
receiving, by a resource processing node, the task processing request; and creating, based on the task processing request, schedulable resource information and sending the schedulable resource information to the scheduler; and
executing, by the scheduler according to the resource acquiring request and the schedulable resource information, resource scheduling on the task to be processed, to obtain a resource scheduling result; and sending the resource scheduling result to the resource processing node and the task processor.
